(19) United States
(12) Patent Application Publication
(10) Pub. No.: US 2012/0206501 A1
(43) Pub. Date: Aug. 16, 2012

(54) METHOD OF DRIVING LIGHT SOURCE AND DISPLAY APPARATUS FOR PERFORMING THE SAME

(75) Inventors: Dae-Gwang JANG, Incheon (KR); Min-Ha KEUM, Cheonan-si (KR); Hak-Mo CHOI, Seoul (KR)

(73) Assignee: SAMSUNG ELECTRONICS CO., LTD., Suwon-si (KR)

(21) Appl. No.: 13/241,525

(22) Filed: Sep. 23, 2011

(30) Foreign Application Priority Data
Feb. 14, 2011 (KR) 2011-0012623

(51) Int. Cl. G09G 3/36; G09G 5/10

(52) U.S. Cl. 345/690; 345/102

(57) ABSTRACT

A method of driving a light source comprises gradually decreasing a luminance of a light emitted from an upper light emitting module disposed along a first side of a display panel during a frame where the first side corresponds to a start point of a scanning direction; and gradually increasing a luminance of a light emitted from a lower light emitting module disposed along a second side of the display panel during the frame where the second side corresponds to an end point of the scanning direction.

### CROSS-REFERENCE TO RELATED APPLICATION

This application claims priority to Korean Patent Application No. 2011-0012623, filed on Feb. 14, 2011, and all the benefits accruing therefrom under 35 U.S.C. §119, the content of which in its entirety is herein incorporated by reference.

### BACKGROUND OF THE INVENTION

1. Field of the Invention

Exemplary embodiments of the present invention generally relate to a method of driving a light source and a display apparatus for performing the method. More particularly, exemplary embodiments of the present invention relate to a method of driving a light source improving a display quality and a display apparatus for performing the method.

2. Description of the Related Art

Generally, a liquid crystal display (“LCD”) apparatus includes an LCD panel displaying an image using a light transmittance of a liquid crystal and a light source module providing a light to the LCD panel. The light source module may be a backlight assembly, for example.

The LCD panel generally includes a first substrate having pixel electrodes and thin film transistors (“TFTs”) connected to the pixel electrodes, a second substrate having a common electrode and color filters, and a liquid crystal layer disposed between the first and second substrates.

The light source module includes a plurality of light sources generating a light required to display an image on the LCD panel. The light sources may include at least one of a cold cathode fluorescent lamp (“CCFL”), an external electrode fluorescent lamp (“EEFL”), a flat fluorescent lamp (“FFL”), and a light emitting diode (“LED”), for example. Recently, the LED having substantially low power consumption and being eco-friendly has been broadly used.

When a video image is displayed on the LCD panel, a boundary of an object in the video image is blurred so that a display quality of the LCD panel is deteriorated.

### BRIEF SUMMARY OF THE INVENTION

Exemplary embodiments of the present invention provide a method of driving a light source capable of decreasing a motion picture response time (“MPRT”) of a display apparatus to substantially improve a display quality of the display apparatus.

Exemplary embodiments of the present invention also provide a display apparatus for performing the method of driving the light source.

In an exemplary embodiment of a method of driving a light source according to the present invention, the method includes gradually decreasing a luminance of a light emitted from an upper light emitting module disposed along a first side of a display panel during a frame where the first side corresponds to a start point of a scanning direction, and gradually increasing a luminance of a light emitted from a lower light emitting module disposed along a second side of the display panel during the frame where the second side corresponds to an end point of the scanning direction.

In the exemplary embodiment, gradually decreasing the luminance of the light emitted from the upper light emitting module may include determining a plurality of upper duty ratios using a plurality of upper masks which corresponds to a plurality of time periods of the frame, generating an upper driving signal, which is time-divided, using the plurality of upper duty ratios, and providing the upper driving signal to the upper light emitting module.

In the exemplary embodiment, gradually increasing the luminance of the light emitted from the lower light emitting module may include determining a plurality of lower duty ratios using a plurality of lower masks which corresponds to the plurality of time periods of the frame, generating a lower driving signal, which is time-divided, using the plurality of lower duty ratios, and providing the lower driving signal to the lower light emitting module.

In the exemplary embodiment, the upper masks may include first to N-th upper masks which have gradually decreasing values where N is a natural number. The lower masks may include first to N-th lower masks which have gradually increasing values.

In the exemplary embodiment, the values of the first to N-th upper masks may be respectively equal to the values of the N-th to first lower masks.

In the exemplary embodiment, the upper driving signal may include first to N-th upper driving signals which are time-divided in the frame. The lower driving signal may include first to N-th lower driving signals which are time-divided in the frame.

In the exemplary embodiment, determining the upper duty ratios may include multiplying an input duty ratio inputted from outside by the values of the upper masks. Determining the lower duty ratios may include multiplying the input duty ratio by the values of the lower masks.

In the exemplary embodiment, the upper and lower light emitting modules may respectively include K light emitting blocks which are independently driven, where K is a natural number. Determining the upper duty ratios may include determining a plurality of upper dimming duty ratios based on image data. Determining the lower duty ratios may include determining a plurality of lower dimming duty ratios based on the image data.

In the exemplary embodiment, determining the upper duty ratios may further include multiplying the K upper dimming duty ratios by the values of the upper masks. Determining the lower duty ratios may further include multiplying the K lower dimming duty ratios by the values of the lower masks.

In an exemplary embodiment of a display apparatus according to the present invention, the display apparatus includes a display panel, a light source part and a light source driver. The display panel displays an image. The light source part includes an upper light emitting module disposed along a first side of the display panel and a lower light emitting module disposed along a second side of the display panel. The first side corresponds to a start point of a scanning direction. The second side corresponds to an end point of the scanning direction. The light source driver drives the upper and lower light emitting modules to gradually decrease a luminance of a light emitted from the upper light emitting module during a frame and to gradually increase a luminance of a light emitted from the lower light emitting module during the frame.

In the exemplary embodiment, the upper and lower light emitting modules may extend in a direction substantially parallel to a gate line of the display panel.

In the exemplary embodiment, at least one of the upper and lower light emitting modules may extend along a relatively longer side of the display panel.

In the exemplary embodiment, the light source driver may include a duty ratio determining part and a signal generator. The duty ratio determining part may determine a plurality of upper duty ratios using a plurality of upper masks corresponding to a plurality of time periods of the frame and a plurality of lower duty ratios using a plurality of lower masks corresponding to the plurality of time periods of the frame. The signal generator may generate an upper driving signal, which is time-divided, using the plurality of upper duty ratios, and a lower driving signal, which is time-divided, using the plurality of lower duty ratios.

In the exemplary embodiment, the upper masks may include first to N-th upper masks having gradually decreasing values where N is a natural number. The lower masks may include first to N-th lower masks having gradually increasing values.

In the exemplary embodiment, the values of the first to N-th upper masks may be respectively equal to the values of the N-th to first lower masks.

In the exemplary embodiment, the upper driving signal may include first to N-th upper driving signals which are time-divided in the frame. The lower driving signal may include first to N-th lower driving signals which are time-divided in the frame.

In the exemplary embodiment, the duty ratio determining part may determine the plurality of upper duty ratios by multiplying an input duty ratio inputted from outside by the values of the upper masks and the plurality of lower duty ratios by multiplying the input duty ratio by the values of the lower masks.

In the exemplary embodiment, the upper and lower light emitting modules may respectively include K light emitting blocks which are independently driven where K is a natural number. The light source driver may further include a dimming level determining part which receives image data and determines a plurality of dimming duty ratios of the light emitting blocks.

In the exemplary embodiment, the dimming level determining part may determine the plurality of upper duty ratios by multiplying K upper dimming duty ratios determined by the dimming level determining part by the upper masks and the plurality of lower duty ratios by multiplying K lower dimming duty ratios determined by the dimming level determining part by the lower masks.

According to the method of driving the light source and the display apparatus for performing the method, an upper light emitting module and a lower light emitting module are driven by a time division driving method so that the MPRT of the display apparatus may be decreased. Thus, a display quality of the display apparatus may be substantially improved.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is an exploded perspective view illustrating an exemplary embodiment of a display apparatus according to the present invention;

FIG. 2 is a block diagram illustrating an exemplary embodiment of a light source driver of FIG. 1;

FIG. 3 is a timing diagram illustrating an exemplary embodiment of an upper driving control signal and a lower driving control signal of FIG. 2;

FIG. 4 is a graph illustrating an exemplary embodiment of a luminance according to a position in a display panel of FIG. 1;

FIG. 5 is a block diagram illustrating another exemplary embodiment of a light source driver according to the present invention; and

FIG. 6 is a timing diagram illustrating an exemplary embodiment of upper driving control signals and lower driving control signals of FIG. 5.

### DETAILED DESCRIPTION OF THE INVENTION

The general inventive concept now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the present invention will be described in further detail with reference to the accompanying drawings.

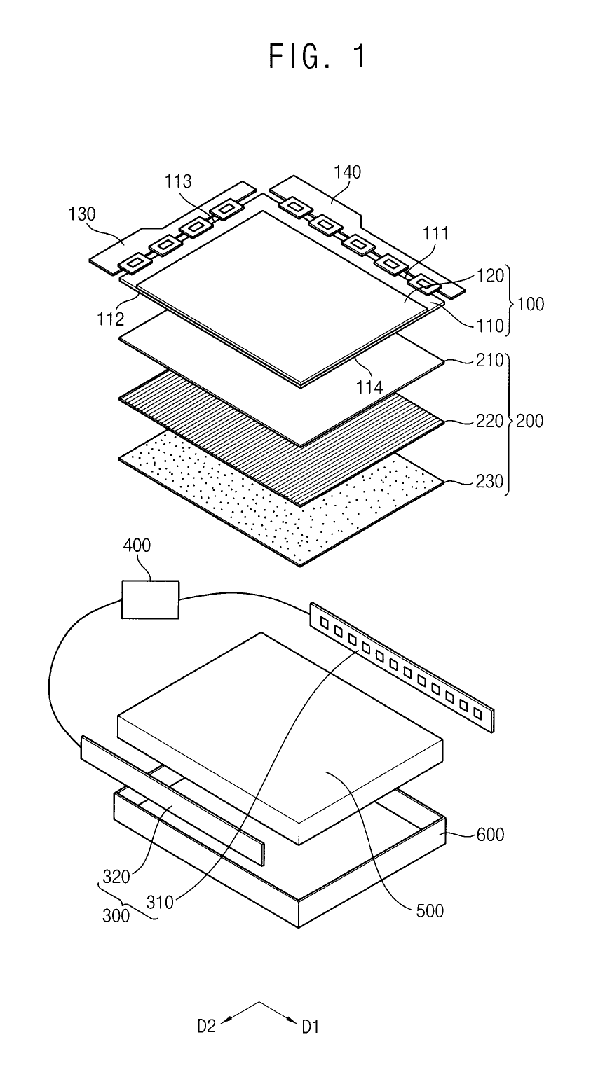

FIG. 1 is an exploded perspective view illustrating an exemplary embodiment of a display apparatus according to the present invention.

Referring to FIG. 1, the display apparatus includes a display panel 100, a light adjusting part 200, a light source part 300, a light source driver 400, a light guide plate 500 and a receiving container 600.

The display panel 100 displays an image. The display panel 100 includes a first substrate 110, a second substrate 120, a liquid crystal layer (not shown), a gate driver 130 and a data driver 140.

The first substrate 110 may include a thin film transistor (“TFT”). The first substrate 110 includes a plurality of gate lines extending in a first direction D1 and a plurality of data lines extending in a second direction D2 substantially perpendicular to the first direction D1.

In one exemplary embodiment, the first substrate 110 may have a rectangular shape. The first substrate 110 may include a first side 111 extending substantially parallel to the first direction D1, a second side 112 facing the first side 111, a third side 113 facing the gate driver 130 and extending substantially parallel to the second direction D2, and a fourth side 114 facing the third side 113. The first and second sides 111 and 112 of the first substrate 110 may be relatively longer than the third and fourth sides 113 and 114 of the first substrate 110. The first to fourth sides 111, 112, 113 and 114 may be regarded as first to fourth sides of the display panel 100 for convenience of explanation.

In one exemplary embodiment, the display panel 100 may include M gate lines. A first gate line may be disposed adjacent to the first side 111 of the display panel 100. An M-th gate line may be disposed adjacent to the second side 112 of the display panel 100. In the present exemplary embodiment, M is a natural number. In one exemplary embodiment, M may be 1080, for example, but is not limited thereto.

During a frame, the gate lines are sequentially driven from the first gate line to the M-th gate line. In the present exemplary embodiment, a direction from the first side 111 of the display panel 100 to the second side 112 of the display panel 100 may be defined as a scanning direction. The first side 111 corresponds to a start point of the scanning direction. The second side 112 corresponds to an end portion of the scanning direction. Referring to FIG. 1, the scanning direction may be substantially parallel to the second direction D2.

The second substrate 120 faces the first substrate 110. In one exemplary embodiment, the second substrate 120 may include a color filter.

The liquid crystal layer (not shown) is disposed between the first substrate 110 and the second substrate 120.

The gate driver 130 and the data driver 140 are connected to the first substrate 110 to output driving signals to the first substrate 110.

In one exemplary embodiment, the gate driver 130 may include a first flexible printed circuit board (“FPC”), a first driving chip mounted on the first FPC and a first printed circuit board (“PCB”) connected to a first end of the first FPC. The first FPC and the first driving chip may form a tape carrier package (“TCP”) or a chip on film (“COF”). The gate driver 130 may include a plurality of the first FPCs and the first driving chips. The gate driver 130 may be integrated on the first substrate 110.

In one exemplary embodiment, the data driver 140 may include a second FPC, a second driving chip mounted on the second FPC and a second PCB connected to a first end of the second FPC. The second FPC and the second driving chip may form a TCP or a COF. The data driver 140 may include a plurality of second FPCs and the second driving chips. The data driver 140 may be integrated on the first substrate 110.

The light adjusting part 200 may include a protecting sheet 210, a prism sheet 220, and a diffusion sheet 230, for example.

The protecting sheet 210 protects the prism sheet 220 against damage such as a scratch, for example.

The prism sheet 220 may include a plurality of prisms disposed in a uniform gap. In one exemplary embodiment, each of the plurality of prisms may have a triangular shape. The prism sheet 220 condenses a light diffused by the diffusion sheet 230 in a direction substantially perpendicular to the display panel 100. However, the prism sheet 220 is not limited thereto, and the prism sheet 220 may include a prism having other various shapes.

The diffusion sheet 230 includes a base substrate and a coating layer disposed on the base substrate. In one exemplary embodiment, the coating layer may include a bead. In one exemplary embodiment, the bead may have a globular shape. The diffusion sheet 230 diffuses a light provided from the backlight assembly so that luminance uniformity may be substantially improved. However the diffusion sheet 230 is not limited thereto and the diffusion sheet 230 may include a pattern having other various shapes.

In one exemplary embodiment, the light adjusting part 200 may further include a dual brightness enhancement film (“DBEF”). The DBEF includes a luminance of a light provided to the display panel 100. In one exemplary embodiment, the DBEF may be disposed on the prism sheet 220.

The light source part 300 generates a light. The light source part 300 includes an upper light emitting module 310 and a lower light emitting module 320. The upper light emitting module 310 is disposed along the first side 111 of the display panel 100. The lower light emitting module 320 is disposed along the second side 112 of the display panel 100.

Although the upper and lower light emitting modules 310 and 320 are disposed along the relatively longer sides of the display panel 100 in the above mentioned exemplary embodiment, the upper and lower light emitting modules 310 and 320 may be disposed along the relatively shorter sides of the display panel 100 depending on the scanning direction of the display panel 100.

Furthermore, although the upper and lower light emitting modules 310 and 320 are disposed along the relatively longer sides of the display panel 100 in the above mentioned exemplary embodiment, in one exemplary embodiment, the light source part 300 may further include light emitting modules disposed along the relatively shorter sides of the display panel 100. Thus, the upper light emitting module 310 in the illustrated exemplary embodiment is not limited to the upper position. The upper light emitting module 310 in the above mentioned exemplary embodiment may be a left light emitting module or a right emitting module depending on the scanning direction. In addition, the lower light emitting module 320 in the illustrated exemplary embodiment is not limited to the lower position. The lower light emitting module 320 in the above mentioned exemplary embodiment may be a left light emitting module or a right emitting module depending on the scanning direction.

In one exemplary embodiment, the upper light emitting module 310 is disposed corresponding to the start point of the scanning direction, and the lower light emitting module 320 is disposed corresponding to the end point of the scanning direction. The upper and lower light emitting modules 310 and 320 may extend in a direction substantially parallel to the gate lines.

In one exemplary embodiment, the upper and lower light emitting modules 310 and 320 may include a light emitting diode string including light emitting diodes (“LEDs”) connected with each other in series.

The upper and lower light emitting modules 310 and 320 may include a plurality of light emitting blocks. In one exemplary embodiment, the upper light emitting module 310 may include sixteen light emitting blocks. In one exemplary embodiment, the lower light emitting module 320 may include sixteen light emitting blocks, but is not limited thereto. The light emitting block includes a plurality of LEDs. In one exemplary embodiment, the light emitting block may include seven or eight LEDs, for example, but is not limited thereto.

The light source part 300 outputs the light to the light guide plate 500. The light source part 300 may be disposed facing a side surface of the light guide plate 500. In one exemplary embodiment, the upper light emitting module 310 may be disposed facing a first side surface of the light guide plate 500. The lower light emitting module 320 may be disposed facing a second side surface of the light guide plate 500 facing the first side surface.

The light source driver 400 drives the light source part 300. The light source driver 400 is electrically connected to the upper and lower light emitting modules 310 and 320.

The light source driver 400 may be disposed out of the receiving container 600. In one exemplary embodiment, the light source driver 400 may be disposed facing a rear surface of a bottom plate of the receiving container 600.

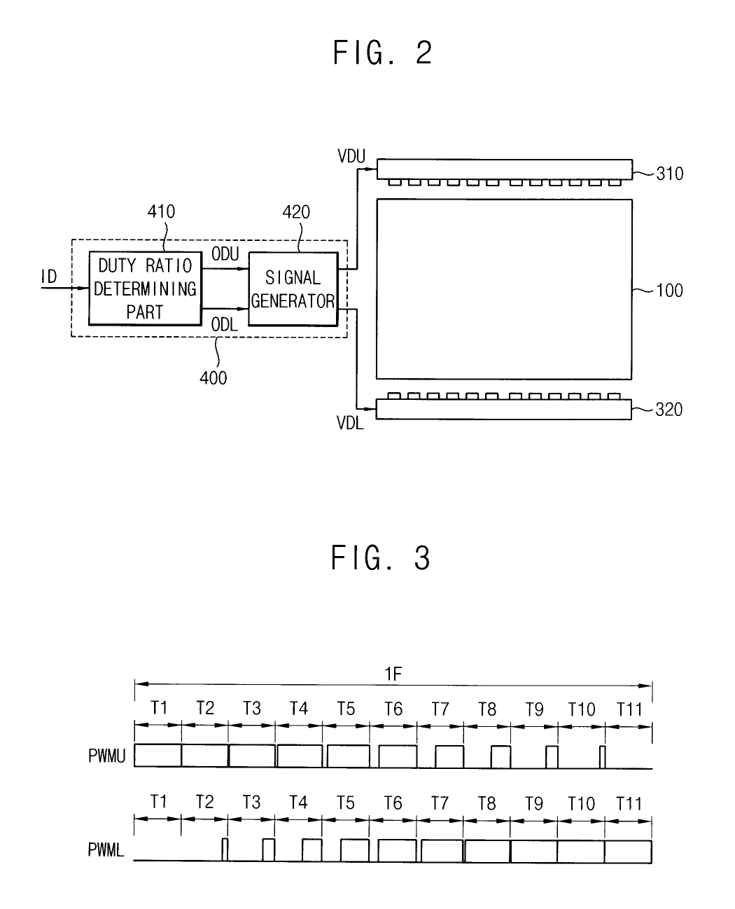

An exemplary embodiment of an operation of the light source driver 400 is explained in detail referring to FIGS. 2 to 4.

The light guide plate 500 guides a light generated from the light source part 300 to the display panel 100. In one exemplary embodiment, the light guide plate 500 may include a rectangular parallelepiped shape, for example. In one exemplary embodiment, the light guide plate 500 may include a wedge shape in a cross-sectional view. However, the light guide plate 500 is not limited thereto, and the light guide plate 500 may include a prism having other various shapes. In one exemplary embodiment, guiding patterns guiding a light may be disposed on a surface of the light guide plate 500. In one exemplary embodiment, the guiding patterns of the light guide plate 500 may have a uniform shape, but is not limited thereto, and may have an ununiform shape.

Although not shown in figures, the display apparatus may further include a reflective plate disposed between the light guide plate 500 and the receiving container 600.

Although not shown in figures, in one exemplary embodiment, the display apparatus may further include an upper receiving container disposed on the display panel 100 and combined with the receiving container 600 and a mold frame substantially improving rigidity of the display apparatus.

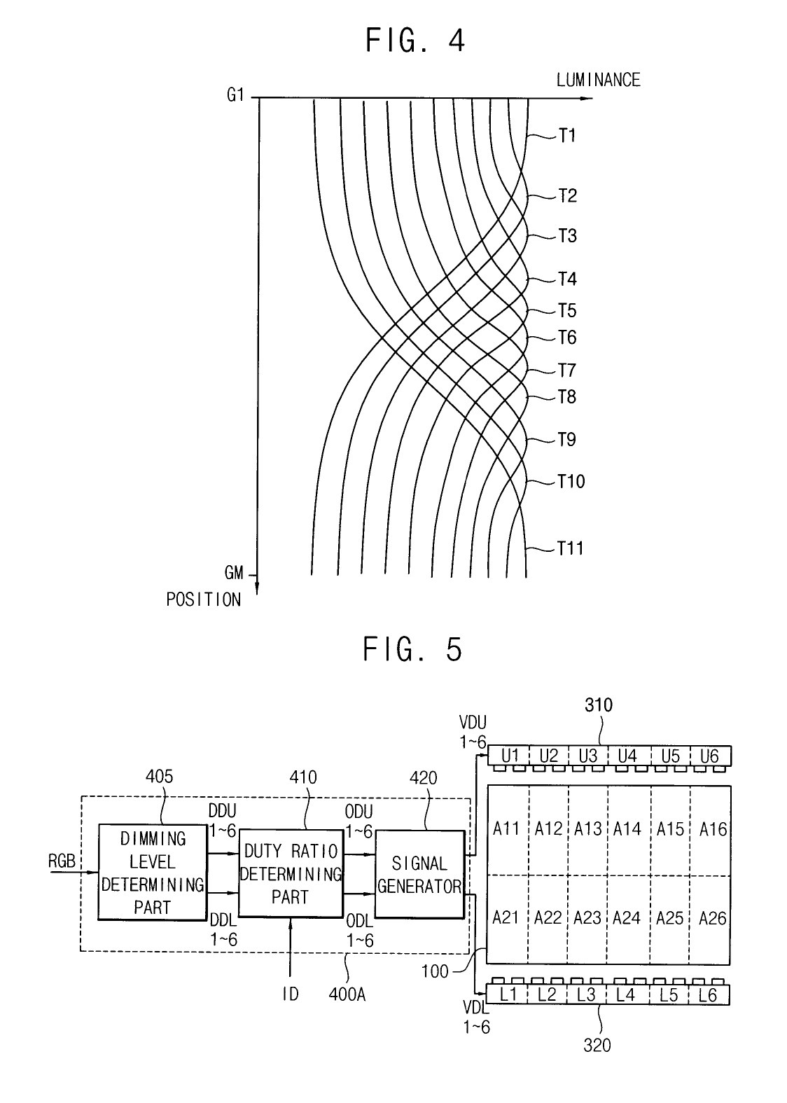

FIG. 2 is a block diagram illustrating an exemplary embodiment of the light source driver 400 of FIG. 1. FIG. 3 is a timing diagram illustrating an exemplary embodiment of an upper driving control signal and a lower driving control signal of FIG. 2. FIG. 4 is a graph illustrating an exemplary embodiment of a luminance according to a position in the display panel 100 of FIG. 1.

Referring to FIGS. 1 and 2, the light source driver 400 is electrically connected to the upper light emitting module 310 and the lower light emitting module 320 to drive the upper and the lower light emitting modules 310 and 320.

The light source driver 400 receives an input duty ratio ID from outside. In one exemplary embodiment, the light source driver 400 may receives the input duty ratio ID from a timing controller (not shown), for example, but is not limited thereto. The light source driver 400 generates an upper driving signal VDU for driving the upper light emitting module 310 and a lower driving signal VDL for driving the lower light emitting module 320. The light source driver 400 outputs the upper driving signal VDU to the upper light emitting module 310 and the lower driving signal VDL to the lower light emitting module 320.

The light source driver 400 drives the upper and lower light emitting modules 310 and 320 to gradually increase a luminance of a light emitted from the upper light emitting module 310 and to gradually decrease a luminance of a light emitted from the lower light emitting module 320 in one frame.

The light source driver 400 drives the upper and lower light emitting modules 310 and 320 by a time division driving method, in which one frame is divided into a plurality of time periods. One frame may be divided into N time periods, where N is a natural number. In one exemplary embodiment, N may be equal to or greater than 2, but is not limited thereto. In the present exemplary embodiment, N may be greater than 2. When N gets greater, scanning characteristic of the display panel 100 is substantially improved so that a motion picture response time (“MPRT”) of the display panel 100 may be substantially decreased.

The light source driver 400 includes a duty ratio determining part 410 and a signal generator 420.

The duty ratio determining part 410 determines a plurality of upper duty ratios ODU using a plurality of upper masks.

The upper masks have values corresponding to the time periods of the frame. In one exemplary embodiment, when one frame is divided into N time periods, for example, the upper masks are first to N-th upper masks. The first to N-th upper masks may have gradually decreasing values.

The duty ratio determining part 410 determines a plurality of lower duty ratios ODL using a plurality of lower masks.

The lower masks have values corresponding to the time periods of the frame. In one exemplary embodiment, when one frame is divided into N time periods, for example, the lower masks are first to N-th lower masks. The first to N-th lower masks may have gradually increasing values.

The first to N-th upper masks are respectively equal to the N-th to first lower masks. That is, the first upper mask is equal to the N-th lower mask, the second upper mask is equal to the (N−1)-th lower mask, the third upper mask is equal to the (N−2)-th lower mask, the (N−2)-th upper mask is equal to the third lower mask, the (N−1)-th upper mask is equal to the second lower mask, and the N-th upper mask is equal to the first lower mask, for example.

The upper and lower masks may be adjusted according to optical characteristics of the display panel 100. In one exemplary embodiment, the upper and lower masks may be adjusted according to straightness and spreadability of a light emitted from the upper and lower light emitting modules 310 and 320, for example. In one exemplary embodiment, the upper and lower masks may be adjusted according to a light guiding characteristic of the light guide plate 500, for example.

Although not shown in figures, the light guide plate 500 has a shape to substantially increase a light emitting rate at a central portion of the display panel 100. Accordingly, a light emitted from the upper light emitting module 310 rarely passes to a lower area of the display panel 100, and a light emitted from the lower light emitting module 320 rarely passes to an upper area of the display panel 100. Thus, the upper light emitting module 310 and the lower light emitting module 320 may be substantially more independently driven from each other compared to a light guide plate does not have a shape to substantially increase a light emitting rate at a central portion of the display panel.

In addition, the light guide plate 500 has a shape to substantially increase a light emitting rate at a central portion of each divided portion when the upper and lower driving signals VDU and VDL are respectively divided into N time periods and the light guide plate 500 is divided into N portions corresponding to the N time periods. Thus, a scanning characteristic of each divided portion of the light guide plate 500 may be substantially improved.

TABLE 1

| | T1 | T2 | T3 | T4 | T5 | T6 | T7 | T8 | T9 | T10 | T11 |
|---|---|---|---|---|---|---|---|---|---|---|---|
| Upper masks (%) | 100 | 100 | 99.2 | 95.2 | 88.8 | 80 | 59.2 | 40.8 | 24.8 | 11.2 | 0 |
| Lower masks (%) | 0 | 11.2 | 24.8 | 40.8 | 59.2 | 80 | 88.8 | 95.2 | 99.2 | 100 | 100 |

Table 1 represents the upper masks and the lower masks. Referring to Table 1, values of the upper and lower masks are represented in percentages (%) of duty ratios of LEDs among full duty ratios of the LEDs. In the present exemplary embodiment, N is 11. One frame is divided into eleven time periods T1 to T11. The upper masks are first to eleventh upper masks. The lower masks are first to eleventh lower masks.

The first to eleventh upper masks have gradually decreasing values, for example, the third upper mask is 99.2, which is smaller than the second upper mask of 100. The fourth upper mask is 95.2, which is smaller than the third upper mask of 99.2.

The first to eleventh upper masks may have same values in a specific portion, for example, the second upper mask is 100, which is equal to the first upper mask of 100.

Unlike Table 1, the first to eleventh upper masks may have increasing values in a specific portion.

The first to eleventh lower masks have gradually increasing values, for example, the second lower mask is 11.2, which is greater than the first lower mask of 0. The third lower mask is 24.8, which is greater than the second lower mask of 11.2.

The first to eleventh lower masks may have same values in a specific portion, for example, the eleventh lower mask is 100, which is equal to the tenth lower mask of 100.

Unlike Table 1, the first to eleventh lower masks may have decreasing values in a specific portion.

The first to eleventh upper masks are equal to the eleventh to first lower masks, for example, the first upper mask is equal to the eleventh lower mask. The second upper mask is equal to the tenth lower mask. As a result, the upper masks are symmetrical to the lower masks.

In one exemplary embodiment, the duty ratio determining part 410 may receive the input duty ratio ID from outside. In one exemplary embodiment, the duty ratio determining part 410 may receive the input duty ratio ID from the timing controller (not shown), but is not limited thereto. In one exemplary embodiment, the input duty ratio ID may be preset by a manufacturer and stored in the timing controller (not shown), for example. In one alternative exemplary embodiment, the input duty ratio ID may be set by a user in real time.

The input duty ratio ID represents a luminance of the display panel 100. When the input duty ratio ID increases, a luminance of the display panel 100 increases, and when the input duty ratio ID decreases, a luminance of the display panel 100 decreases. Thus, the input duty ratio ID may be set considering power consumption of the display apparatus, and be modified depending on outside brightness in real time.

The duty ratio determining part 410 determines the upper duty ratios ODUs based on the input duty ratio ID. The duty ratio determining part 410 may determine the upper duty ratios ODUs by multiplying the input duty ratio ID by the values of the upper masks. The duty ratio determining part 410 outputs the upper duty ratios ODUs to the signal generator 420.

The duty ratio determining part 410 determines the lower duty ratios ODLs based on the input duty ratio ID. The duty ratio determining part 410 may determine the lower duty ratios ODLs by multiplying the input duty ratio ID by the values of the lower masks. The duty ratio determining part 410 outputs the lower duty ratios ODLs to the signal generator 420.

The signal generator 420 receives the upper duty ratios ODUs and the lower duty ratios ODLs from the duty ratio determining part 410.

The signal generator 420 generates an upper driving signal VDU, which is time-divided, using the upper duty ratios ODUs and a lower driving signal VDL, which is time-divided, using the lower duty ratios ODLs.

The signal generator 420 outputs the upper driving signal VDU to the upper light emitting module 310 and the lower driving signal VDL to the lower light emitting module 320.

When one frame is divided into N time periods, the upper driving signal VDU includes first to N-th upper driving signals, and the lower driving signal VDL includes first to N-th lower driving signals.

In one exemplary embodiment, the signal generator 420 may include a driving control signal generator (not shown) and a converter (not shown).

The driving control signal generator generates an upper driving control signal using the upper duty ratios ODUs. In one exemplary embodiment, the upper driving control signal may be a pulse width modulation (“PWM”) signal.

The driving control signal generator generates a lower driving control signal using the lower duty ratios ODLs. In one exemplary embodiment, the lower driving control signal may be a PWM signal.

In one exemplary embodiment, the driving control signal generator may be an integrated circuit.

Referring to Table 1 and FIG. 3, the upper driving control signal PWMU and the lower driving control signal PWML may be explained in detail.

In the present exemplary embodiment, the input duty ratio ID is 100%, the upper and lower masks are the values in Table 1, and one frame 1F is divided into eleven time periods.

The N-th upper duty ratio is a multiplication of the input duty ratio ID by the value of the N-th upper mask, for example, the first upper duty ratio is a multiplication of the input duty ratio ID by the first upper mask, which is 100(%)×100(%)=100(%). The second upper duty ratio is a multiplication of the input duty ratio ID by the value of the second upper mask, which is 100(%)×100(%)=100(%). The third upper duty ratio is a multiplication of the input duty ratio ID by the value of the third upper mask, which is 100(%)×99.2(%)=99.2(%).

The upper driving control signal PWMU has the N-th upper duty ratio during an N-th time period, for example, the upper driving control signal PWMU has the first upper duty ratio during a first time period T1, the second upper duty ratio during a second time period T2 and the third upper duty ratio during a third time period T3.

The N-th lower duty ratio is a multiplication of the input duty ratio ID by the value of the N-th lower mask, for example, the first lower duty ratio is a multiplication of the input duty ratio ID by the value of the first lower mask, which is 100(%)×0(%)=0(%). The second lower duty ratio is a multiplication of the input duty ratio ID by the value of the second lower mask, which is 100(%)×11.2(%)=11.2(%). The third lower duty ratio is a multiplication of the input duty ratio ID by the value of the third lower mask, which is 100(%)×24.8(%)=24.8(%).

The lower driving control signal PWML has the N-th lower duty ratio during an N-th time period, for example, the lower driving control signal PWML has the first lower duty ratio during the first time period T1, the second lower duty ratio during the second time period T2 and the third lower duty ratio during the third time period T3.

The converter generates the upper driving signal VDU in response to the upper driving control signal PWMU. The converter outputs the upper driving signal VDU to the upper light emitting module 310.

The converter generates the lower driving signal VDL in response to the lower driving control signal PWML. The converter outputs the lower driving signal VDU to the lower light emitting module 320.

In one exemplary embodiment, the converter may include a switching element.

Referring to Table 1 and FIGS. 2 to 4, during the first time period T1, the upper driving signal VDU is generated using the first upper duty ratio of 100% and the lower driving signal VDL is generated using the first lower duty ratio of 0% so that a luminance of a light emitted from the upper light emitting module 310 is substantially higher than a luminance of a light emitted from the lower light emitting module 320, a luminance of a portion adjacent to the first gate line G1 is the highest, and a luminance of the display panel 100 decreases from the first gate line G1 to an M-th gate line GM.

During the second time period T2, the upper driving signal VDU is generated using the second upper duty ratio of 100% and the lower driving signal VDL is generated using the second lower duty ratio of 11.2% so that a luminance of a light emitted from the upper light emitting module 310 is substantially higher than a luminance of a light emitted from the lower light emitting module 320, and a luminance of an upper portion of the display panel 100 is substantially higher than a luminance of a lower portion of the display panel 100. A portion having a highest luminance is shifted to a relatively low portion along the scanning direction compared to the first time period T1.

During the third time period T3, the upper driving signal VDU is generated using the third upper duty ratio of 99.2% and the lower driving signal VDL is generated using the third lower duty ratio of 24.8% so that a luminance of a light emitted from the upper light emitting module 310 is substantially higher than a luminance of a light emitted from the lower light emitting module 320, and a luminance of an upper portion of the display panel 100 is substantially higher than a luminance of a lower portion of the display panel 100. A portion having the highest luminance is shifted to a relatively low portion along the scanning direction compared to the second time period T2.

During the sixth time period T6, the upper driving signal VDU is generated using the sixth upper duty ratio of 80% and the lower driving signal VDL is generated using the sixth lower duty ratio of 80% so that a luminance of a light emitted from the upper light emitting module 310 is substantially equal to a luminance of a light emitted from the lower light emitting module 320, and a luminance of an upper portion of the display panel 100 is substantially equal to a luminance of a lower portion of the display panel 100. A portion having the highest luminance is shifted to a relatively low portion along the scanning direction compared to a fifth time period T5. During the sixth time period T6, the portion having the highest luminance is a central portion of the display panel 100 in the scanning direction.

During the seventh time period T7, the upper driving signal VDU is generated using the seventh upper duty ratio of 59.2% and the lower driving signal VDL is generated using the seventh lower duty ratio of 88.8% so that a luminance of a light emitted from the lower light emitting module 320 is substantially higher than a luminance of a light emitted from the upper light emitting module 310, and a luminance of a lower portion of the display panel 100 is substantially higher than a luminance of an upper portion of the display panel 100. A portion having the highest luminance is shifted to a relatively low portion along the scanning direction compared to the sixth time period T6.

During the eighth time period T8, the upper driving signal VDU is generated using the eighth upper duty ratio of 40.8% and the lower driving signal VDL is generated using the eighth lower duty ratio of 95.2% so that a luminance of a light emitted from the lower light emitting module 320 is substantially higher than a luminance of a light emitted from the upper light emitting module 310, and a luminance of a lower portion of the display panel 100 is substantially higher than a luminance of an upper portion of the display panel 100. A portion having the highest luminance is shifted to a relatively low portion along the scanning direction compared to the seventh time period T7.

According to the above mentioned exemplary embodiment, a luminance of a light emitted from the upper light emitting module 310 gradually decreases and a luminance of a light emitted from the lower light emitting module 310 gradually increases during one period, so that the MPRT of the display apparatus may be decreased.

In addition, the upper and lower masks are properly adjusted so that a luminance uniformity of the display panel 100 may be substantially easily improved.

Thus, a display quality of the display apparatus may be substantially improved.

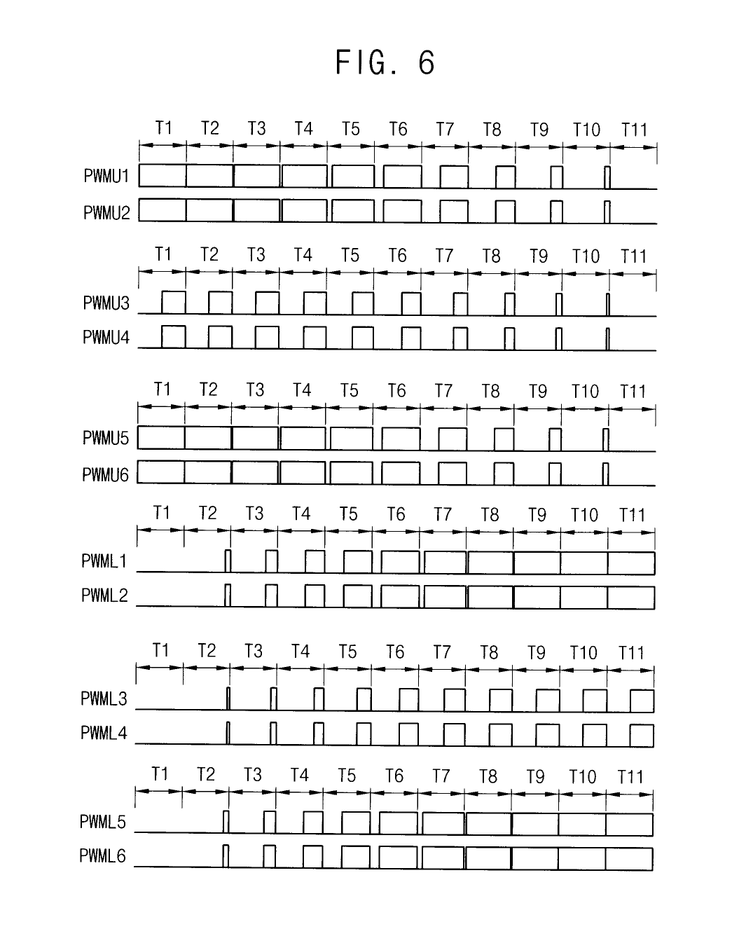

FIG. 5 is a block diagram illustrating another exemplary embodiment of a light source driver 400A according to the present invention. FIG. 6 is a timing diagram illustrating an exemplary embodiment of upper driving control signals and lower driving control signals of FIG. 5.

The another exemplary embodiment of a display apparatus is substantially the same as the display apparatus of the previous illustrated exemplary embodiment explained referring to FIGS. 1 to 4 except that the light source driver 400A includes a dimming level determining part 405. Thus, the same reference numerals may be used to refer to the same or like parts as those described in the previous exemplary embodiment of FIGS. 1 to 4 and any repetitive explanation concerning the above elements may be omitted.

In addition, the another exemplary embodiment of a method of driving a light source is substantially the same as the method of driving a light source of the previous illustrated exemplary embodiment explained referring to FIGS. 1 to 4 except that light emitting blocks of the upper and lower light emitting modules are independently driven. Thus, the same reference numerals may be used to refer to the same or like parts as those described in the previous exemplary embodiment of FIGS. 1 to 4 and any repetitive explanation concerning the above elements may be omitted.

Referring to FIGS. 1 and 5, the light source part 300 includes an upper light emitting module 310 and a lower light emitting module 320. The upper light emitting module 310 may be disposed along the first side 111 of the display panel 100. The lower light emitting module 320 may be disposed along the second side 112 of the display panel 100.

The upper and lower light emitting modules 310 and 320 includes a plurality of light emitting blocks. The upper light emitting module 310 includes K upper light emitting blocks, and the lower light emitting module 320 includes K lower light emitting blocks, where K is a natural number. In the present exemplary embodiment, K is 6, for example.

The upper light emitting module 310 includes first to sixth upper light emitting blocks U1, U2, U3, U4, U5 and U6. The lower light emitting module 320 includes first to sixth lower light emitting blocks L1, L2, L3, L4, L5 and L6.

Accordingly, the display panel 100 may be divided into twelve display blocks. The display panel 100 includes first to twelfth display blocks A11, A12, A13, A14, A15, A16, A21, A22, A23, A24, A25 and A26.

The first to sixth upper light emitting blocks U1 to U6 may be independently driven. The first to sixth lower light emitting blocks L1 to L6 may be independently driven.

The light source driver 400A is electrically connected to the upper light emitting module 310 and the lower light emitting module 320 to drive the upper and the lower light emitting modules 310 and 320.

The light source driver 400A receives image data RGB and an input duty ratio ID from outside. The light source driver 400A generates a plurality of upper driving signals VDU1 to VDU6 for driving the upper light emitting blocks U1 to U6 and a plurality of lower driving signals VDL1 to VDL6 for driving the lower light emitting blocks L1 to L6. The light source driver 400A outputs the upper driving signals VDU1 to VDU6 to the upper light emitting module 310 and the lower driving signals VDL1 to VDL6 to the lower light emitting module 320.

The light source driver 400A drives the upper and lower light emitting modules 310 and 320 to gradually increase a luminance of a light emitted from the upper light emitting module 310 and to gradually decrease a luminance of a light emitted from the lower light emitting module 320 in one frame.

In detail, the light source driver 400A drives the upper and lower light emitting modules 310 and 320 to gradually increase a luminance of a light emitted from the upper light emitting blocks U1 to U6 and to gradually decrease a luminance of a light emitted from the lower light emitting blocks L1 to L6 in one frame.

The light source driver 400A includes a dimming level determining part 405, a duty ratio determining part 410 and a signal generator 420.

The dimming level determining part 405 receives the image data RGB from outside. The dimming level determining part 405 may receive the image data RGB from the timing controller (not shown) or an external set. The dimming level determining part 405 determines a dimming duty ratio using the image data RGB.

The dimming level determining part 405 determines first to sixth upper dimming duty ratios DDU1 to DDU6 for driving the first to sixth upper light emitting blocks U1 to U6. The dimming level determining part 405 determines first to sixth lower dimming duty ratios DDL1 to DDL6 for driving the first to sixth lower light emitting blocks L1 to L6.

The dimming level determining part 405 may determine the dimming duty ratio using a representative luminance value of the light emitting block. The representative luminance value may be a maximum grayscale value, an average grayscale value, or a weighted average grayscale value in the light emitting block.

The duty ratio determining part 410 determines a plurality of upper duty ratios ODU1 to ODU6 using a plurality of upper masks. In one exemplary embodiment, the first to N-th upper masks may have gradually decreasing values.

The duty ratio determining part 410 determines a plurality of lower duty ratios ODL1 to ODL6 using a plurality of lower masks. In one exemplary embodiment, the first to N-th lower masks may have gradually increasing values.

The duty ratio determining part 410 determines the upper duty ratios ODU1 to ODU6 by multiplying K upper dimming duty ratios DDU1 to DDU6 by the values of the upper masks. The duty ratio determining part 410 may determine the upper duty ratios ODU1 to ODU6 by multiplying the K upper dimming duty ratios DDU1 to DDU6 by the values of the upper masks by the input ratio ID.

The duty ratio determining part 410 determines the lower duty ratios ODL1 to ODL6 by multiplying K lower dimming duty ratios DDL1 to DDL6 by the values of the lower masks. The duty ratio determining part 410 may determine the lower duty ratios ODL1 to ODL6 by multiplying the K lower dimming duty ratios DDL1 to DDL6 by the values of the lower masks by the input ratio ID.

The signal generator 420 receives the upper duty ratios ODU1 to ODU6 and the lower duty ratios ODL1 to ODL6 from the duty ratio determining part 410.

The signal generator 420 generates upper driving signals VDU1 to VDU6, which are time-divided, using the upper duty ratios ODU1 to ODU6 and generates lower driving signals VDL1 to VDL6, which are time-divided, using the lower duty ratios ODL1 to ODL6.

The signal generator 420 outputs the upper driving signals VDU1 to VDU6 to the upper light emitting module 310 and the lower driving signals VDL1 to VDL6 to the lower light emitting module 320.

In detail, the signal generator 420 may include a driving control signal generator (not shown) generating an upper driving control signal and a lower driving control signal and a converter (not shown) outputting the upper driving signals VDU1 to VDU6 and the lower driving signals VDL1 to VDL6.

Referring to Table 1 and FIG. 6, the upper driving control signals PWMU1 to PWMU6 and the lower driving control signals PWML1 to PWML6 may be explained in detail.

In the present exemplary embodiment, the input duty ratio ID is 100%, the upper and lower masks are the values in Table 1, and one frame 1F is divided into eleven time periods.

In addition, the upper dimming duty ratios DDU1 to DDU6 are respectively 100(%), 100(%), 50(%), 50(%), 100(%) and 100(%). The lower dimming duty ratios DDL1 to DDL6 are respectively 100(%), 100(%), 50(%), 50(%), 100(%) and 100(%).

Hereinafter, the first upper driving control signal PWMU1 is explained. The first duty ratio is a multiplication of the first upper dimming duty ratio DDU1 by the value of the first upper mask, which is 100(%)×100(%)=100(%). The second upper duty ratio is a multiplication of the first upper dimming duty ratio DDU1 by the value of the second upper mask, which is 100(%)×100(%)=100(%). The third upper duty ratio is a multiplication of the first upper dimming duty ratio DDU1 by the value of the third upper mask, which is 100(%)×99.2(%)=99.2(%). The fourth upper duty ratio is a multiplication of the first upper dimming duty ratio DDU1 by the value of the fourth upper mask, which is 100(%)×95.2(%)=95.2(%). The fifth upper duty ratio is a multiplication of the first upper dimming duty ratio DDU1 by the value of the fifth upper mask, which is 100(%)×88.8(%)=88.8(%). The sixth upper duty ratio is a multiplication of the first upper dimming duty ratio DDU1 by the value of the sixth upper mask, which is 100(%)×80(%)=80(%).

The first upper driving control signal PWMU1 has the first upper duty ratio during the first time period T1, the second upper duty ratio during the second time period T2, the third upper duty ratio during the third time period T3, the fourth upper duty ratio during the fourth time period T4, the fifth upper duty ratio during the fifth time period T5, the sixth upper duty ratio during the sixth time period T6, the seventh upper duty ratio during the seventh time period T7, the eighth upper duty ratio during the eighth time period T8, the ninth upper duty ratio during the ninth time period T9, the tenth upper duty ratio during the tenth time period T10 and the eleventh upper duty ratio during the eleventh time period T11.

The second, fifth and sixth upper driving control signals PWMU2, PWMU5 and PWMU6 have substantially the same waveforms as that of the first upper driving control signal PWMU1.

Hereinafter, the third upper driving control signal PWMU3 is explained. The first duty ratio is a multiplication of the third upper dimming duty ratio DDU3 by the value of the first upper mask, which is 50(%)×100(%)=50(%). The second upper duty ratio is a multiplication of the third upper dimming duty ratio DDU3 by the value of the second upper mask, which is 50(%)×100(%)=50(%). The third upper duty ratio is a multiplication of the third upper dimming duty ratio DDU3 by the value of the third upper mask, which is 50(%)×99.2(%)=49.6(%). The fourth upper duty ratio is a multiplication of the third upper dimming duty ratio DDU3 by the value of the fourth upper mask, which is 50(%)×95.2(%)=47.6(%). The fifth upper duty ratio is a multiplication of the third upper dimming duty ratio DDU3 by the value of the fifth upper mask, which is 50(%)×88.8(%)=44.4(%). The sixth upper duty ratio is a multiplication of the third upper dimming duty ratio DDU3 by the value of the sixth upper mask, which is 50(%)×80(%)=40(%).

The third upper driving control signal PWMU3 has the first upper duty ratio during the first time period T1, the second upper duty ratio during the second time period T2, the third upper duty ratio during the third time period T3, the fourth upper duty ratio during the fourth time period T4, the fifth upper duty ratio during the fifth time period T5, the sixth upper duty ratio during the sixth time period T6, the seventh upper duty ratio during the seventh time period T7, the eighth upper duty ratio during the eighth time period T8, the ninth upper duty ratio during the ninth time period T9, the tenth upper duty ratio during the tenth time period T10 and the eleventh upper duty ratio during the eleventh time period T11.

The fourth driving control signal PWMU4 has substantially the same waveform as that of the third upper driving control signal PWMU3.

Hereinafter, the first lower driving control signal PWML1 is explained. The first duty ratio is a multiplication of the first lower dimming duty ratio DDL1 by the value of the first lower mask, which is 100(%)×0(%)=0(%). The second lower duty ratio is a multiplication of the first lower dimming duty ratio DDL1 by the value of the second lower mask, which is 100(%)×11.2(%)=11.2(%). The third lower duty ratio is a multiplication of the first lower dimming duty ratio DDL1 by the value of the third lower mask, which is 100(%)×24.8(%)=24.8(%). The fourth lower duty ratio is a multiplication of the first lower dimming duty ratio DDL1 by the value of the fourth lower mask, which is 100(%)×40.8(%)=40.8(%). The fifth lower duty ratio is a multiplication of the first lower dimming duty ratio DDL1 by the value of the fifth lower mask, which is 100(%)×59.2(%)=59.2(%). The sixth lower duty ratio is a multiplication of the first lower dimming duty ratio DDL1 by the value of the sixth lower mask, which is 100(%)×80(%)=80(%).

The first lower driving control signal PWML1 has the first lower duty ratio during the first time period T1, the second lower duty ratio during the second time period T2, the third lower duty ratio during the third time period T3, the fourth lower duty ratio during the fourth time period T4, the fifth lower duty ratio during the fifth time period T5 and the sixth lower duty ratio during the sixth time period T6, the seventh lower duty ratio during the seventh time period T7, the eighth lower duty ratio during the eighth time period T8, the ninth lower duty ratio during the ninth time period T9, the tenth lower duty ratio during the tenth time period T10 and the eleventh lower duty ratio during the eleventh time period T11.

The second, fifth and sixth lower driving control signals PWML2, PWML5 and PWML6 have substantially the same waveforms as that of the first lower driving control signal PWML1.

Hereinafter, the third lower driving control signal PWML3 is explained. The first duty ratio is a multiplication of the third lower dimming duty ratio DDL3 by the value of the first lower mask, which is 50(%)×0(%)=0(%). The second lower duty ratio is a multiplication of the third lower dimming duty ratio DDL3 by the value of the second lower mask, which is 50(%)×11.2(%)=5.6(%). The third lower duty ratio is a multiplication of the third lower dimming duty ratio DDL3 by the value of the third lower mask, which is 50(%)×24.8(%)=12.4(%). The fourth lower duty ratio is a multiplication of the third lower dimming duty ratio DDL3 by the value of the fourth lower mask, which is 50(%)×40.8(%)=20.4(%). The fifth lower duty ratio is a multiplication of the third lower dimming duty ratio DDL3 by the value of the fifth lower mask, which is 50(%)×59.2(%)=29.6(%). The sixth lower duty ratio is a multiplication of the third lower dimming duty ratio DDL3 by the value of the sixth lower mask, which is 50(%)×80(%)=40(%).

The third lower driving control signal PWML3 has the first lower duty ratio during the first time period T1, the second lower duty ratio during the second time period T2, the third lower duty ratio during the third time period T3, the fourth lower duty ratio during the fourth time period T4, the fifth lower duty ratio during the fifth time period T5, the sixth lower duty ratio during the sixth time period T6, the seventh lower duty ratio during the seventh time period T7, the eighth lower duty ratio during the eighth time period T8, the ninth lower duty ratio during the ninth time period T9, the tenth lower duty ratio during the tenth time period T10 and the eleventh lower duty ratio during the eleventh time period T11.

The fourth driving control signal PWML4 has substantially the same waveform as that of the third lower driving control signal PWML3.

The converter generates the upper driving signals VDU1 to VDU6 in response to the upper driving control signals PWMU1 to PWMU6. The converter outputs the upper driving signals VDU1 to VDU6 to the upper light emitting module 310.

The converter generates the lower driving signals VDL1 to VDL6 in response to the lower driving control signals PWML1 to PWML6. The converter outputs the lower driving signals VDL1 to VDL6 to the lower light emitting module 320.

According to the above mentioned exemplary embodiment, a luminance of a light emitted from the upper light emitting module 310 gradually decreases and a luminance of a light emitted from the lower light emitting module 310 gradually increases during one period, so that the MPRT of the display apparatus may be substantially decreased.

In addition, the upper and lower masks are properly adjusted so that a luminance uniformity of the display panel 100 may be substantially easily improved.

Thus, a display quality of the display apparatus may be substantially improved.

Furthermore, the light emitting blocks of the upper and lower light emitting modules 310 and 320 are independently driven so that power consumption of the display apparatus may be substantially decreased.

According to the present invention as explained above, the upper light emitting module 310 and the lower light emitting module 320 are driven by the time division driving method so that the MPRT of the display apparatus may be substantially decreased. Thus, a display quality of the display apparatus may be substantially improved.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A method of driving a light source, the method comprising:
gradually decreasing a luminance of a light emitted from an upper light emitting module disposed along a first side of a display panel during a frame where the first side corresponds to a start point of a scanning direction; and
gradually increasing a luminance of a light emitted from a lower light emitting module disposed along a second side of the display panel during the frame where the second side corresponds to an end point of the scanning direction.

2. The method of claim 1, wherein gradually decreasing the luminance of the light emitted from the upper light emitting module includes:
determining a plurality of upper duty ratios using a plurality of upper masks which corresponds to a plurality of time periods of the frame;
generating an upper driving signal, which is time-divided, using the plurality of upper duty ratios; and
providing the upper driving signal to the upper light emitting module.

3. The method of claim 2, wherein gradually increasing the luminance of the light emitted from the lower light emitting module includes:
determining a plurality of lower duty ratios using a plurality of lower masks which corresponds to the plurality of time periods of the frame;
generating a lower driving signal, which is time-divided, using the plurality of lower duty ratios; and
providing the lower driving signal to the lower light emitting module.

4. The method of claim 3, wherein the upper masks include first to N-th upper masks which have gradually decreasing values where N is a natural number, and
the lower masks include first to N-th lower masks which have gradually increasing values.

5. The method of claim 4, wherein the values of the first to N-th upper masks are respectively equal to the values of the N-th to first lower masks.

6. The method of claim 4, wherein the upper driving signal includes first to N-th upper driving signals which are time-divided in the frame, and
the lower driving signal includes first to N-th lower driving signals which are time-divided in the frame.

7. The method of claim 3, wherein determining the upper duty ratios includes multiplying an input duty ratio inputted from outside by the values of the upper masks, and
determining the lower duty ratios includes multiplying the input duty ratio by the values of the lower masks.

8. The method of claim 3, wherein the upper and lower light emitting modules respectively include K light emitting blocks which are independently driven where K is a natural number,
determining the upper duty ratios includes determining a plurality of upper dimming duty ratios based on image data, and
determining the lower duty ratios includes determining a plurality of lower dimming duty ratios based on the image data.

9. The method of claim 8, wherein determining the upper duty ratios further includes multiplying the K upper dimming duty ratios by the values of the upper masks, and
determining the lower duty ratios further includes multiplying the K lower dimming duty ratios by the values of the lower masks.

10. A display apparatus comprising:
a display panel which displays an image; and
a light source part which includes an upper light emitting module disposed along a first side of the display panel and a lower light emitting module disposed along a second side of the display panel, the first side which corresponds to a start point of a scanning direction, the second side which corresponds to an end point of the scanning direction; and
a light source driver which drives the upper and lower light emitting modules to gradually decrease a luminance of a light emitted from the upper light emitting module during a frame and to gradually increase a luminance of a light emitted from the lower light emitting module during the frame.

11. The display apparatus of claim 10, wherein the upper and lower light emitting modules extend in a direction substantially parallel to a gate line of the display panel.

12. The display apparatus of claim 11, wherein at least one of the upper and lower light emitting modules extend along a relatively longer side of the display panel.

13. The display apparatus of claim 10, wherein the light source driver includes:
a duty ratio determining part which determines a plurality of upper duty ratios using a plurality of upper masks which corresponds to a plurality of time periods of the frame and a plurality of lower duty ratios using a plurality of lower masks which corresponds to the plurality of time periods of the frame; and
a signal generator generating an upper driving signal, which is time-divided, using the plurality of upper duty ratios, and a lower driving signal, which is time-divided, using the plurality of lower duty ratios.

14. The display apparatus of claim 13, wherein the upper masks include first to N-th upper masks which have gradually decreasing values where N is a natural number, and
the lower masks include first to N-th lower masks which have gradually increasing values.

15. The display apparatus of claim 14, wherein the values of the first to N-th upper masks are respectively equal to the values of the N-th to first lower masks.

16. The display apparatus of claim 14, wherein the upper driving signal includes first to N-th upper driving signals which are time-divided in the frame, and
the lower driving signal includes first to N-th lower driving signals which are time-divided in the frame.

17. The display apparatus of claim 13, wherein the duty ratio determining part determines the plurality of upper duty ratios by multiplying an input duty ratio inputted from outside by the values of the upper masks, and the plurality of lower duty ratios by multiplying the input duty ratio by the values of the lower masks.

18. The display apparatus of claim 13, wherein the upper and lower light emitting modules respectively include K light emitting blocks which are independently driven where K is a natural number, and
the light source driver further includes a dimming level determining part which receives image data and determines a plurality of dimming duty ratios of the light emitting blocks.

19. The display apparatus of claim 18, wherein the dimming level determining part determines the plurality of upper duty ratios by multiplying K upper dimming duty ratios determined by the dimming level determining part by the upper masks, and the plurality of lower duty ratios by multiplying K lower dimming duty ratios determined by the dimming level determining part by the lower masks.
